(19) United States
(12) Patent Application Publication
(10) Pub. No.: US 2026/0336686 A1
(43) Pub. Date: Oct. 29, 2026

(54) METHODS AND APPARATUS FOR A STEERING SYSTEM

(71) Applicant: Ford Global Technologies, LLC, Dearborn, MI (US)

(72) Inventors: Alexander Ein Waldt, Koln (DE); Gerhard Friederich, Bornheim (DE); Sergio Codonesu, Aachen (DE); Oliver Nehls, Düsseldorf (DE); Goetz-Philipp Wegner, Dortmund (DE)

(21) Appl. No.: 19/578,255

(22) Filed: Mar. 25, 2026

(30) Foreign Application Priority Data
Apr. 23, 2025 (DE) 102025115587.9

(51) Int. Cl. B62D 5/04; B62D 5/00; B62D 6/02; H02P 25/22; H02P 29/028

(52) U.S. Cl. CPC B62D 5/046; B62D 5/006; B62D 5/0493; B62D 6/02; H02P 25/22; H02P 29/028

(57) ABSTRACT

The disclosure relates to a vehicle and, more particularly, to methods and apparatus for a steering system. An example steer-by-wire (SBW) steering system comprising an electric motor including a first winding set and a second winding set, a first motor control device to apply first phase voltages to the first winding set based on a torque request associated with the electric motor, and a second motor control device coupled to the first motor control device to apply second phase voltages to the second winding set when the torque request is greater than a first threshold.

### RELATED APPLICATION

This patent claims priority from DE Patent Application Number 102025115587.9, which was filed on Apr. 23, 2025, and is hereby incorporated by reference in its entirety.

### FIELD OF THE DISCLOSURE

The disclosure relates to a vehicle and, more particularly, to methods and apparatus for a steering system.

### BACKGROUND

Conventional vehicle steering systems typically employ mechanical linkages, such as steering columns, racks, and pinions, to transmit driver input from a steering wheel to one or more road wheels. Steer-by-wire steering systems replace at least a portion of the mechanical linkage with electronic sensors, control units, and actuators configured to detect steering input and generate corresponding control signals to position one or more steerable road wheels of the vehicle.

### SUMMARY

An example steer-by-wire (SBW) steering system comprising an electric motor including a first winding set and a second winding set, a first motor control device to apply first phase voltages to the first winding set based on a torque request associated with the electric motor, and a second motor control device coupled to the first motor control device to apply second phase voltages to the second winding set when the torque request is greater than a first threshold.

An example non-transitory computer readable storage medium comprising instructions to cause at least one programmable circuitry to select a first motor control device or a second motor control device based on a first temperature of the first motor control device and a second temperature of the second motor control device, cause at least one of the first motor control device or the second motor control device to apply first phase voltages to a first winding set of an electric motor based on the selection and a torque request associated with the electric motor, and when the torque request associated with the electric motor is greater than a first threshold, cause at least one of the first motor control device or the second motor control device to apply second phase voltages to a second winding set of the electric motor.

An example method comprising selecting a first motor control device or a second motor control device based on a first temperature of the first motor control device and a second temperature of the second motor control device, causing at least one of the first motor control device or the second motor control device to apply first phase voltages to a first winding set of an electric motor based on the selection and a torque request associated with the electric motor, and when the torque request associated with the electric motor is greater than a first threshold, causing at least one of the first motor control device or the second motor control device to apply second phase voltages to a second winding set of the electric motor.

### BRIEF DESCRIPTION OF DRAWINGS

FIG. 1 a schematic representation of a vehicle including a steering system according to examples described herein.

FIG. 2 is a flowchart representative of example machine readable instructions and/or example operations that may be executed, instantiated, and/or performed by example programmable circuitry to implement the control device of FIG. 1.

FIGS. 3 and 4 are schematic representations of torque curves related to examples described herein.

FIG. 5 is a block diagram of an example processing platform including programmable circuitry structured to execute, instantiate, and/or perform the example machine readable instructions and/or perform the example operations of FIG. 2 to implement the control device of FIG. 1.

### DETAILED DESCRIPTION

A steer-by-wire steering system (hereinafter SBW steering system) and most electrically assisted steering systems, such as electric power assisted steering (EPAS) systems, use electric motors with multiple motor control devices to provide redundancy for motor control. The required motor torque is evenly distributed to the motor control devices, except for minor differences. In such control topologies, one of the motor control devices exerts a primary control logic, considering the requested motor torque (e.g., a torque request), to distribute the requested motor torque among the individual motor control devices. Appropriate control signals are then communicated between the motor control devices so that the individual motor control devices can cause the corresponding torque output of at least one electric motor.

However, due to different running times and different control accuracies of the different motor control devices, the resulting torque differs from the required torque. Asynchronies between the different proportions of the motor torque can lead to increased noise, vibration, and harshness (NVH) interference of the respective steering actuator. In addition, the lower the torque to be produced by a motor control device, the worse the signal-to-noise ratio becomes. Poor signal-to-noise ratios in turn lead to increased NVH interference. Corresponding NVH interference or a correspondingly reduced signal-to-noise ratio cause control inaccuracies, so that the operating efficiency of the steering system is reduced by increased electrical power dissipation.

One known solution includes a steering control device for maintaining operating characteristics that do not change when conditions are normal and when impairment occurs. The solution includes a relatively large number of motors to drive a steered (or steerable) road wheel and a relatively large number of control units, each of which is assigned to one of the motors. When the steering control device is operating normally, a torque command is generated that represents the torque required to rotate the steerable road wheel. The torque command is divided according to the number of motors. Each of the control units regulates the corresponding motors according to a corresponding of the distributed torques.

Another known solution includes a system with subsystems, each of which has a motor to drive a steering mechanism depending on the rotational movement of a steering wheel. A first control unit and a second control unit monitor each other's error states of the systems to stop a faulty system in each case. If the respective systems are normal, the first control unit and the second control unit drive the first motor and the second motor of their own systems to drive the steering mechanism through the interaction of the respective motors. If one of the two systems is faulty, the control unit of the other system will only control the motor of its own system to drive the steering mechanism.

Examples described herein solve all or at least some of the above described problems. An example steering system described herein includes at least one electric motor and two motor control devices. Each motor control device is assigned to at least one electric motor. The motor control devices are coupled to each other. At least one motor control device is configured to determine or receive a torque requirement for at least one electric motor. Each motor control device is configured to apply phase voltages depending on the torque requirement to windings of at least one winding set of an electric motor, so that phase currents are driven in the windings. The motor control devices are configured in such a way that phase voltages are provided only by a single motor control device if the torque requirement is less than a first specified torque threshold.

Examples described herein are based on the finding that in specific operating scenarios, a single motor control device is sufficient to apply demand-based phase voltages to the windings of the electric motor according to the torque requirement. This avoids runtime differences and asynchronies that can otherwise be caused by using multiple motor control devices at the same time. Because only a single motor control device is used, NVH interference is reduced. In addition, the signal-to-noise ratio can be increased by using a single motor control device instead of multiple motor control devices for a specific torque requirement, especially in the low to medium torque range. Both effects mean that the control of the steering system with respect to the electric motor is more precise than before, which reduces the power losses caused during operation, thus increasing the operational efficiency of the steering system. In addition, the steering system configured in this way also allows the service life of the components of the engine control device to be extended. Because only a single motor control device is used in specific operating scenarios, depending on the torque requirement, the components of other motor control devices can pause operation. Corresponding motor control devices, for example, have switching devices that therefore have to perform fewer gear changes. This can reduce the wear and tear of these components, resulting in an extended service life of the corresponding components. The first specified torque threshold value serves as a limitation of the corresponding torque range up to which it makes sense to apply an electric motor from a single motor control device, for example without overloading the individual motor control device.

Optionally, the motor control devices are configured to provide phase voltages from multiple motor control devices if the torque requirement is greater than the first specified torque threshold. By switching on at least one additional motor control device at higher torque requirements, a better power distribution is achieved, which prevents load peaks regarding individual motor control devices. This results in a longer service life of the system as well as increased freedom from operational errors.

In some examples, the motor control devices may be configured in such a way that the torque of the several motor control devices are caused by at least one electric motor. A pairwise difference between the torque generated by different motor control devices may be less than a predetermined differential threshold. The limitation of the pairwise torque difference allows all motor control devices to work closely together. This minimizes load imbalances, which ensures uniform loading of the components and stable control of the required torque.

In some examples, the differential threshold can be specified by user input or by at least one of the motor control devices, depending on the operating situation of the steering system. The differential threshold is a measure of how much the torque produced by the multiple motor control devices may diverge from each other in pairs. This essentially ensures equal loading of the multiple motor control devices.

In some examples, the motor control devices may be configured in such a way that of the several motor control devices, respective torques are caused by at least one electric motor. A torque produced by a first motor control device may be constant. A torque caused by another motor control device can vary in correspondence with a variation in the torque requirement until the pairwise difference between the torques caused by different motor control devices is less than a predetermined difference threshold or until the torque requirement is greater than a second predetermined torque threshold.

Once the torque requirement is greater than the first torque threshold, this triggers the operation of the steering system with simultaneous output of phase voltages from multiple motor control devices. The torque requirement then has a variation compared to the first torque threshold. While the torque produced by the first motor control device can be kept constant, the power output of at least one other motor control device can be varied according to the change in the torque requirement up to the above criteria and in particular increased, at least to the extent necessary due to the torque requirement, so that a varying torque is caused. The constant torque of the first motor control device with simultaneous varying additional torque of at least one other motor control device allows for “fine control” by at least one other motor control device with regard to the torque requirement, provided that it exceeds the first specified torque threshold. The torque produced by the at least one other motor control device can then be brought close to the torque of the first motor control device until the several motor control devices are subjected to the same loads. This achieves a very precise and at the same time efficient adaptation to the desired torque requirement. This prevents unnecessary energy losses and protects the components.

In some examples, the second torque threshold is larger than the first torque threshold. The second torque threshold creates a criterion for when the torques of the motor control devices should be equalized. In some examples, motor control devices are configured to provide phase voltages from multiple motor control devices if the torque requirement is greater than a third predetermined torque threshold. The third predetermined torque threshold and the first predetermined torque threshold can be different. For a torque requirement greater than the third predetermined torque threshold, a pairwise difference between the torques produced by different motor control devices may be less than a predetermined differential threshold. The introduction of an additional torque threshold (e.g., the third torque threshold) makes it possible to achieve even finer gradations in operation. This allows the steering system to operate optimally in different torque ranges and the load to be distributed flexibly, which increases overall reliability.

Optionally, the third torque threshold is greater than the first torque threshold. In some examples, the third torque threshold is also larger than the second torque threshold. Once the torque requirement exceeds the third torque threshold, equal torques are forced by the multiple motor control devices except for a pairwise difference. This can prevent singular component loads for individual motor control devices.

In one aspect, the motor control devices may be configured in such a way that, if the phase voltages are to be output by only a single motor control device, a single motor control device is selected based on at least one of an ageing state of at least one motor control device, a temperature of at least one motor control device, a relative position of the windings of the stator to the rotor of the electric motor, wherein the windings of a winding set are each assigned to a motor control device, and a precision criterion (e.g., position data) of a rotor position encoder assigned to a motor control device.

The possibility of preferring a specific motor control device based on the state of aging, temperature, rotor position or precision of the position encoder increases operational flexibility and freedom from operating errors. For example, at elevated temperatures, a less loaded motor control device can be selected to prevent errors. For example, a uniform thermal load on the components of the individual motor control devices can be achieved in this way.

The aging state of at least one motor control device can be determined, for example, by the number of operating cycles, such as switching cycles, or the operating time. For example, the ageing state can be considered in such a way that all motor control devices and their components should age in a similar way. Alternatively, a specific motor control device can be selected so that it and its components age more (e.g., faster) compared to other motor control devices and their components. This can reduce the likelihood of multiple failures occurring simultaneously with different motor control devices. In this way, errors of several motor control devices can be prevented within a short period of time. For example, a temperature of a component of the steering system, such as a motor control device or an electric motor, can be detected based on at least one temperature sensor and received by the motor control device.

In some examples, the motor control device may be configured to estimate a temperature based on the electrical operating characteristics of the motor control device components and/or the electric motor. For example, a temperature can be estimated knowing the supply voltage, and/or the modulation pattern, and/or the switching frequency of switching devices, and/or the signal changes caused by the switching processes (e.g., the slope).

The relative position of the windings of the stator, to which the respective motor control device is assigned, to the rotor of the electric motor has an influence on the control precision. Because the different motor control devices are assigned to different windings of different winding sets, specific motor control devices in some examples can provide higher control precision simply because of the arrangement and design of the electric motor relative to other motor control devices, thereby reducing the electrical power dissipation caused during operation.

The motor control devices are assigned rotor position encoders. Due to the limited installation space and due to manufacturing tolerances, individual rotor position encoders can usually guarantee a higher precision in detecting the rotor position than is the case for other rotor position encoders. The motor control device to which the rotor position encoder with the highest precision is assigned can then be selected accordingly.

Optionally, at least one motor control device is configured to receive or determine the vehicle's speed. The at least one motor control device is configured to account for different initial torque thresholds depending on the vehicle speed. The torque thresholds can be adjusted depending on the vehicle's speed. This ensures situation-dependent and optimized control of the motor control devices, which increases driving comfort and reduces energy consumption.

In general, low vehicle speeds only cause reduced background noise compared to high vehicle speeds, so NVH interference is less masked and therefore more apparent in the case of low vehicle speeds. Therefore, the first torque threshold can be increased depending on the vehicle speed, especially at low vehicle speeds. This means that a single motor control device can be used on its own up to a higher torque requirement to apply phase voltages to the windings of the electric motor as needed. This allows other motor control devices to pause operation until a higher torque requirement is reached.

In some examples, the steering system includes several electric motors. Each electric motor has at least one motor control device assigned to it. The received or determined torque requirement is common to all electric motors. The assignment of one or more motor control devices per electric motor and the joint consideration of the torque requirement enables a scalable, modular system architecture. This means that the steering system can be integrated into a wide range of vehicle topologies without the need for extensive adjustments. For example, the steering system may have two 3-phase electric motors and two motor control devices. One motor control device is assigned to each electric motor. In some examples, the system can also have two 6-phase electric motors and four motor control devices. Two motor control devices are assigned to each electric motor. In some examples, the system can also have a 6-phase electric motor and two motor control devices. Both motor control devices are assigned to the single electric motor. In some examples, the system can also have a 9-phase electric motor and three motor control devices. All motor control devices are assigned to the individual electric motor. Generally, the system can include n 3m-phase electric motors and k motor control devices. Where k=n·m·k, n, and m are non-zero natural numbers. Individual electric motors in a group of electric motors are each assigned a uniform number of motor control devices.

According to a further aspect, examples described herein also enable a vehicle with a steering system as described above. The electric motor and the multiple motor control devices are parts of a hand wheel actuator or a road wheel actuator. The benefits achieved by the steering system described herein are also achieved in a corresponding manner by the vehicle. In particular, this can ensure redundancy for each actuator. At the same time, however, the electrical power dissipation caused during the operation of the actuators is reduced, especially for low and medium torque requirements. In addition, the service life of at least individual components of the actuators is extended.

For the purposes of disclosure, vehicles may include land vehicles, namely, inter alia, off-road and on-road vehicles such as passenger cars, buses, trucks and other commercial vehicles. Motor vehicles can be manned or unmanned. The vehicles can have an internal combustion engine, alternatively an electric motor to drive them, or they can be hybrid vehicles.

According to a further aspect, examples described herein also enable a method for operating a steering system for a vehicle. The steering system includes at least one electric motor and two motor control devices. Each motor control device is assigned to at least one electric motor. The motor control devices are coupled to each other. The method includes at least the following operations. First, a torque requirement for at least one electric motor is received or determined by at least one motor control device. Windings of at least one winding set of an electric motor are subjected to phase voltages depending on the torque requirement of at least one motor control device, so that phase currents are driven in the windings. Finally, Phase voltages are provided only by a single motor control device if the torque requirement is less than a first specified torque threshold.

The advantages achieved by the steering system described herein are also achieved in a corresponding manner by the method. In particular, the operating efficiency of the steering system for low and medium torque requirements is increased by reducing NVH interference by preventing asynchronies by using only a single motor control device. The method reduces complexity and energy requirements in everyday driving situations, thus conserving resources while at the same time providing redundancy.

Optionally, phase voltages are provided by multiple motor control devices if the torque requirement is greater than the first specified torque threshold. The automatic switching to power the electric motor from several motor control devices when the first torque threshold is exceeded allows power to be adjusted according to demand. This results in a higher torque potential and makes the steering system more responsive in specific driving situations, such as evasive maneuvers.

According to a further aspect, examples described herein also enable a computer program product, comprising instructions which, when executed by a processor, cause the computer program product to perform at least partially the method described above, in particular the computational and output operations. The benefits achieved by the method described herein are also achieved in a corresponding manner by the computer program product.

According to an additional aspect, examples described herein also enable a non-transitory computer-readable storage medium, comprising instructions which, when executed by a processor, cause the computer program product to execute at least partially the method described above, in particular the computational and output operations. The advantages achieved by the method described herein are also achieved in a corresponding way by the computer-readable storage medium.

All of the features mentioned below with respect to the examples and/or accompanying figures may be combined, alone or in any sub-combination, with features of the example, including features of preferred examples.

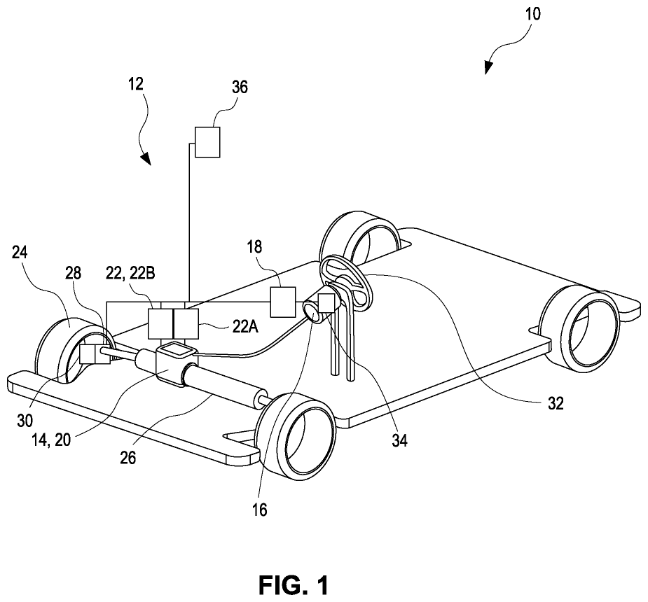

FIG. 1 shows a vehicle 10 including a steering system 12 according to examples described herein. The steering system 12 is configured here as an SBW steering system. Alternatively, the steering system 12 can also have a different topology, such as an EPAS steering system. In some examples, the steering system 12 comprises a road wheel actuator 14 (hereinafter referred to as the “roadwheel actuator”). The steering system 12 also includes a hand wheel actuator 16 (HWA). A steering wheel control device 18 is assigned to HWA 16.

According to this example, the RWA 14 comprises a 6-phase electric motor 20 and a first motor control device 22A and a second motor control device 22B. The motor control devices are generally referred to as 22. In other examples, the RWA 14 may also have several electric motors 20, each of which is assigned at least one motor control device 22. The control device 18 of the HWA 16 is coupled with the engine control devices 22 of the RWA 14.

The steering system 12 is configured as a front-axle steering system as depicted in FIG. 1. In some examples, however, the steering system 12 can also be configured as a rear-axle steering system, in which the rear wheels are steerable. In some examples, both the front and rear wheels can also be steerable. In such examples, several RWAs 14 may be provided, each assigned to different front or rear wheels.

As depicted in FIG. 1, the RWA 14 is indirectly coupled with steerable road wheels 24 of vehicle 10. For this purpose, the electric motor 20 of the RWA 14 is coupled with a rack 26. The rack 26 is coupled with the steerable road wheels 24 of the vehicle 10. The displacement of the rack 26 with respect to a reference position, such as a zero position (e.g., a straight position), results in a change in the orientation of the steerable road wheels 24 around the respective wheel steering axles. In general, the rack 26 can also be omitted. In such an example, the steering system 12 can include several RWAs 14, each of which is assigned to individual steerable road wheels 24 of vehicle 10.

The steering system 12 includes road wheel angle sensors 28, each of which is assigned to a single steerable road wheel 24 of vehicle 10. Each road wheel angle sensor 28 is configured to detect a road wheel steering angle of the respective steerable road wheel 24 around the respective wheel steering axle and to transmit it to the steering wheel control device 18 and/or the motor control devices 22.

In some examples, instead of a road wheel angle sensor 28, the steering system 12 can also include a rack and pinion sensor that detects a position of a rack 26 opposite a reference position. Because the rack 26 is coupled with the steerable road wheels 24, a deflection of the rack 26 leads to a rotation of the steerable road wheels 24 around the respective wheel steering axles. Therefore, the orientation of the steerable road wheels 24 can be determined from the respective rack and pinion position, for example, by the steering wheel control device 18 and/or the motor control devices 22 of the steering system 12.

In some examples, instead of a road wheel angle sensor 28, the steering system 12 may also include a pinion sensor associated with a pinion whose position and/or angular position are affected by a torque output by the electric motor 20 of the RWA 14. The sprocket is also at least indirectly coupled to the steerable road wheels 24. For example, a change in the position and/or angular position of the sprocket can be used to determine a corresponding change in the road wheel angle of a steerable road wheel 24.

In addition, the vehicle 10 includes a speed sensor 30, which can be assigned to at least one road wheel 24 of vehicle 10, for example. The speed sensor 30 is configured to detect the speed of the vehicle 10 and transmit it to the steering wheel control device 18 and/or the motor control devices 22 of the steering system 12. For example, the speed sensor 30 can detect a rotation rate of the assigned road wheel 24 around the running axle and transmit it to the steering wheel control device 18 and/or the engine control devices 22. The control device 18 and/or the motor control device 22 can determine the vehicle speed of the vehicle 10 based on the received rotation rate. In some examples, several speed sensors can be assigned to 30 different road wheels 24 of the vehicle 10. In some examples, several sensor units can also form a sensor together, which enables mutual plausibility checks and redundancy.

The steering system 12 also includes a steering wheel 32, with which the HWA 16 is at least indirectly coupled, for example via a steering column. The HWA 16 is configured to apply feedback torque to the steering wheel 32, giving the driver of the vehicle 10 a feel for the lateral control of the vehicle 10. The driver of vehicle 10 can use the steering wheel 32 to make steering instructions (e.g., inputs) for vehicle 10.

The steering system 12 also includes at least one steering wheel sensor 34 that is configured to detect a steering wheel angle of the steering wheel 32 (e.g., a steering wheel position) with respect to a reference position, such as a center position (e.g., a zero position). Consequently, the steering wheel sensor 34 can be used to detect steering instructions from the driver of the vehicle 10 based on the steering wheel 32. In this respect, a steering input defines a specific current steering wheel angle and steering wheel speed.

A current steering input generally corresponds to a specific current target wheel angle of a steerable road wheel 24, according to which the steerable road wheels 24 are to be aligned. Because the steerable road wheels 24 are at least indirectly coupled to a rack 26 according to this example, a steering input is equivalent to a specific rack position of the rack 26, according to which the rack 26 is to be moved to achieve a desired orientation of the road wheels 24. Alternatively, the previously mentioned pinion position and/or sprocket orientation can also be used as a control variable regarding the steering input.

The steering input detected by the steering wheel sensor 34 on the steering wheel 32 is transmitted by the steering wheel sensor 34 and/or the control device 18 to the motor control devices 22. The motor control devices 22 determine a torque input for at least one electric motor 20 of the RWA 14 based on the steering input. The determined torque input is to be met jointly by all electric motors 20 of the RWA 14.

The motor control devices 22 are each configured to apply phase voltages to windings of a winding set of at least one electric motor 20 of the RWA 14 so that phase currents are driven in the windings. For this purpose, the motor control devices 22 can include, for example, converters, current regulators, and pulse width modulators. The motor control devices 22 are coupled to the at least one electric motor 20 of the RWA 14 in such a way that phase voltages for windings of the electric motor 20 can be output by single motor control devices 22 or by several motor control devices 22 at the same time. The different motor control devices can be assigned 22 different windings.

The motor control devices 22 are configured to accommodate different torque thresholds with respect to the torque requirement. The motor control devices 22 can adjust the torque thresholds depending on other parameters, such as the vehicle speed of the vehicle 10. In addition, the motor control devices 22 communicate with each other, for example to coordinate the output electrical power so that the torques can be assessed. Typically, a single motor control device 22 exerts master functionality over other motor control devices 22 that act as slaves. Nevertheless, the motor control devices 22 are configured in such a way that they are redundant to each other.

In addition, the motor control devices 22 are configured to determine an ageing state of at least one motor control device 22, to determine a temperature of at least one component of a motor control device 22, to determine a rotor position of at least one electric motor 20 of the RWA 14, and to read out a data memory 36 to obtain information on the precision criteria of the different motor control devices 22. The ageing state of at least one motor control device 22 can be determined, for example, by the number of switching operations and/or the operating time of the motor control device 22 or the components thereof. To determine the temperature of at least one component, the motor control device 22 may be coupled with a temperature sensor. Furthermore, the temperature can be estimated based on the electrical operating parameters of the components of the motor control device 22. The rotor position of at least one electric motor 20 can be detected based on a rotor position sensor assigned to the respective motor control device 22. Calibration measurements can be stored in data memory 36 that indicate how precisely a given motor control device 22 can be operated.

The HWA 16 includes an electric motor. Using the electric motor, the HWA 16 can exert torque on the steering wheel 32 that affects the steering wheel angle and/or steering wheel speed, for example based on a control signal from the steering wheel control device 18. For example, the control device 18 can consider the road wheel angle of a steerable road wheel 24, which is detected by the road wheel angle sensor 28. Based on the detected road wheel angle, the steering wheel control device 18 can determine a torque requirement for the feedback torque to be applied to the steering wheel 32 by the HWA 16. Based on the feedback torque, the driver is provided a feeling about the lateral guidance of vehicle 10. According to this example, the steering wheel sensor 34 is integrated into the HWA 16. However, in other examples, the steering wheel sensor 34 can be separate from the HWA 16.

The motor control devices 22 are shown in accordance with this example regarding the electric motor 20 of the RWA 14. However, the HWA 16 can also have several motor control devices 22 that are configured to perform the functionalities described. The corresponding motor control devices 22 would then replace the control device 18 shown here as a single component. In some examples, the steering system 12 can also include several similar and generally functional components, such as several steering wheel sensors 34, thus ensuring redundancy.

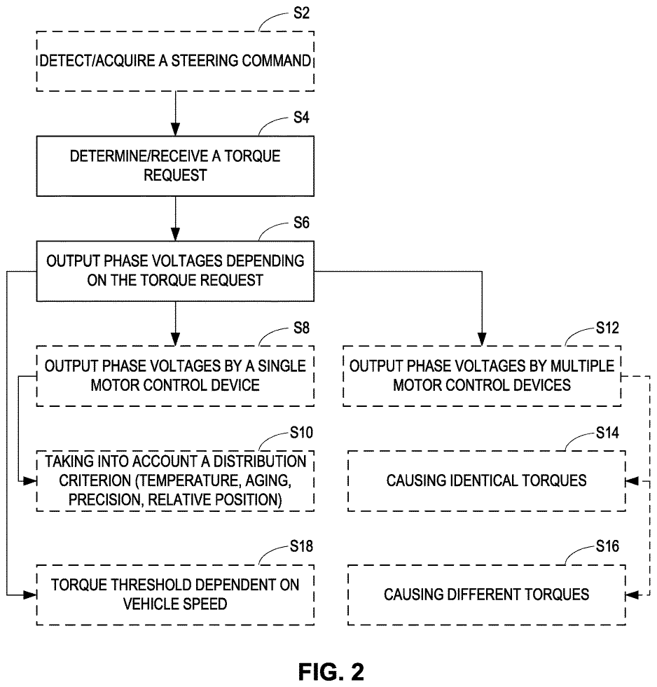

FIG. 2 is a flowchart representative of example machine readable instructions and/or example operations that may be executed, instantiated, and/or performed by example programmable circuitry to implement the motor control devices 22 of FIG. 1. In the optional operation S2, a steering input of the driver at the steering wheel 32 is recorded in accordance with this example of the steering system 12. For example, the steering wheel sensor 34 can be used for this purpose, which detects the steering wheel angle and/or the steering wheel speed of the steering wheel 32. The detected steering wheel angle is transmitted to the motor control devices 22 of the RWA 14.

The procedure is explained below based on the driver's captured steering input. In some examples, the method can also be based on the road wheel angle of steerable road wheels 24 of the vehicle 10 and can be used as a measurement to determine a torque requirement for at least one electric motor of the HWA 16. In such examples, the following explanations are to be transferred correspondingly. In such examples, the HWA 16 would include several motor control devices 22 that perform the functionalities explained below. In addition, only a single electric motor 20 of the RWA 14 is assumed here. In some examples, the RWA 14 can also include several electric motors, each of which is assigned at least one motor control device 22.

In the subsequent operation S4, at least one motor control device 22 determines a torque requirement for the electric motor 20 of the RWA 14 based on the received steering instruction from the driver at the steering wheel 32. In some examples, the captured steering input can also be used by the control device 18 of the HWA 16 to determine a torque requirement and to transmit the torque requirement to the motor control devices 22.

In the subsequent operation S6, windings of at least one winding set of an electric motor 20 of the RWA 14 are subjected to phase voltages depending on the torque requirement by at least one motor control device 22, so that phase currents are driven in the windings. Whether only a single motor control device 22 or several motor control devices 22 output corresponding phase voltages for windings of the electric motor 20 depends on the size of the torque requirement placed on the electric motor 20 of the RWA 14. This means that the motor control device 22 considers an initial specified torque threshold and compares the torque requirement determined for the entirety of all electric motors 20 of the RWA 14 with the first torque threshold. If the comparison shows that the torque requirement is less than the first specified torque threshold value, the procedure is continued with the optional operation S8. According to the optional S8 operation, phase voltages are output by a single motor control device 22 to RWA 14 electric motor windings 20 in case the torque requirement is less than the first predetermined torque threshold.

The optional operation S8 can be further implemented by the optional operation S10. In such examples, motor control device 22 considers a distribution criterion to decide which motor control device 22 outputs the phase voltages to windings of electric motor 20. The distribution criterion refers in particular to one of an ageing state of at least one motor control device 22, a temperature of at least one motor control device 22, a relative position of the windings of the stator to the rotor of the electric motor 20, wherein the windings of a winding set are each assigned to a motor control device 22, and a precision criterion of a rotor position encoder assigned to a motor control device 22.

For example, the motor control device 22 may decide that the motor control devices 22 should have as similar an aging state as possible. As a result, the motor control device 22 can compare the number of switching cycles of switching devices of the motor control devices 22 or the operating time of the motor control devices 22. By analogy, the motor control device 22 can consider a detected or estimated temperature of a component of a motor control device 22 and decide, for example, that the phase voltages are to be output by another motor control device 22. The other distribution criteria can also be used to consider the characteristics and operating parameters of the steering system 12 as required. Corresponding control routines can be stored in the motor control devices 22.

If it is determined in operation S6 that the torque requirement determined in operation S4 is greater than the first specified torque threshold value, the procedure is continued from operation S6 with the optional operation S12. In such examples, phase voltages for the electric motor 20 of the RWA 14 are output from at least several motor control devices 22.

The optional operation S12 can be further implemented by the optional operations S14 and S16. According to the optional operation S14, 22 phase voltages are output from at least two motor control devices to the electric motor 20 of the RWA 14 in such a way that the torques caused by the motor control devices 22 are equal. This means that at least several motor control devices are subjected to 22 equal load conditions as soon as the torque requirement exceeds the first torque threshold.

The optional operation S16 provides that although several motor control devices 22 are used to output phase voltages to the electric motor 20 of the RWA 14, the torques caused by the motor control devices 22 diverge from each other. As soon as the determined torque requirement exceeds the first torque threshold, the torque caused by the motor control device 22A previously used is kept constant. The additional torque required by the increase in the torque requirement is caused by another motor control device 22B, which now also outputs phase voltages to windings of the electric motor 20 of the RWA 14.

The optional operation S16 can be configured in different ways. For example, the torques caused by the additional motor control device 22B used may vary and correspond to the varying torque requirement until the torques generated by all motor control devices 22 used are the same or until the torque requirement exceeds a predetermined second torque threshold. If the torque requirement is further increased, the motor control devices 22 can then be operated in such a way that they produce equal torques except for a specified difference. Optionally, the second torque threshold can be equal to the first torque threshold, resulting in the functionality of operation S16 having the same effect as the functionality outlined with operation S14.

In some examples, the second torque threshold may be greater than the first torque threshold. An additional third torque threshold may also be provided as an option, indicating that all motor control devices used must produce 22 equal torques if the torque requirement exceeds the third torque threshold. Optionally, the third torque threshold can be greater than the second torque threshold and greater than the first torque threshold. The torque thresholds can be set as needed, for example, by the motor control devices 22.

The method can also be further implemented by the optional operation S18. In such examples, at least one motor control device 22 receives a detected or determined vehicle speed of the vehicle 10. In some examples, the motor control device 22 can determine the vehicle speed of the vehicle 10 itself, for example based on a received rotation rate of a road wheel 24. The motor control device 22 then adjusts the first torque threshold depending on the vehicle's speed. For example, a higher first torque threshold can be used for low vehicle speeds, as low vehicle speeds are generally associated with NVH interference.

Overall, the process allows for reduced power losses, as the electric motor 20 can be operated by a single motor control device 22 depending on the torque requirement. This can avoid asynchronies and control errors caused by the operation of the electric motor 20 with multiple motor control devices 22. In addition, the service life of the components of the motor control devices 22 can be extended so that they can pause at least temporarily.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

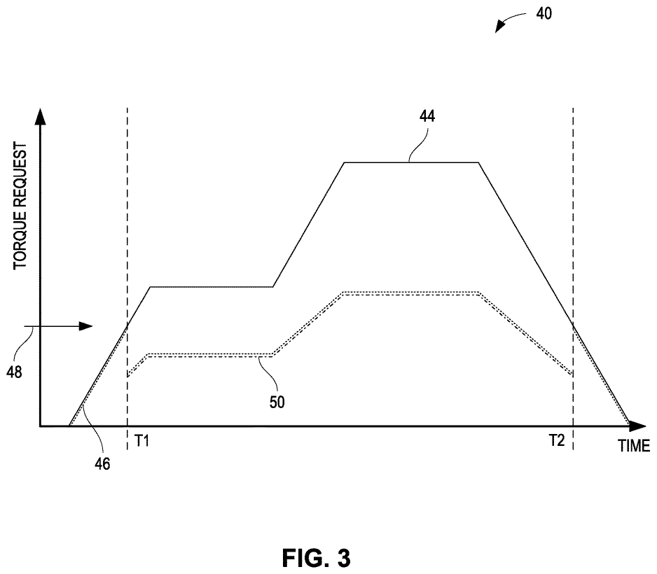

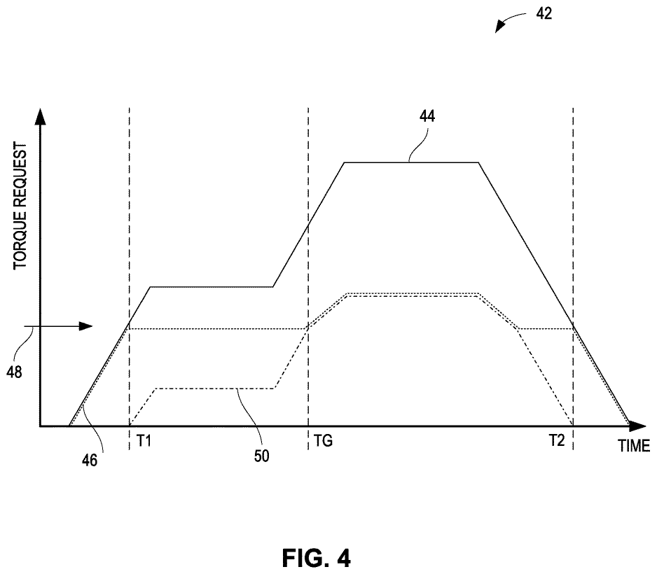

FIGS. 3 and 4 show schematic representations of torque curves 40, 42 related to examples described herein. On the y-axis, the torque requirement and the torque caused by the operation of different motor control devices 22 is plotted compared to the time on the x-axis.

In the torque curve 40 of FIG. 3, the torque requirement 44 increases before time T1. Because the torque requirement 44 for time points prior to T1 is less than the first torque threshold 48, phase voltages to the electric motor 20 of the RWA 14 are output only by a single motor control device 22A, see operation S8. The torque applied is shown as a dotted line 46, which is slightly offset to the torque requirement 44 for better visibility.

At time T1, the torque requirement 44 reaches the first torque threshold value 48. According to the optional operation S14, an additional motor control device 22B is now used to also output phase voltages to windings of the electric motor 20, so that a torque is also generated, shown here by the dash-dotted line 50. According to this configuration, the motor control devices 22 are regulated in such a way that they produce equal torques as soon as the torque requirement 44 exceeds the first torque threshold 48. As a result, the different motor control devices cause 22 torques to be the same. For better visibility, the torques, lines 46, 50, are slightly offset against each other.

At time T2, the torque requirement 44 drops back below the first specified torque threshold value 48. As a result, the power output is terminated by the additional motor control device 22B. After time T2, only a single motor control device 22A is used to apply appropriate phase voltages to windings of the electric motor 20 so that the torque requirement 44 is met.

The torque curve 42 shown in FIG. 4 differs from the torque curve 40 of FIG. 3 in that the motor control device 22A used before time T1 produces a constant torque after the torque requirement 44 has been exceeded by the first torque threshold, see the dotted line 46. The difference between the torque requirement 44 and the first torque threshold value 48 occurring after time T1 is compensated by engaging another motor control device 22B, see the dashed line 50, corresponding to the optional operation S16. The torque produced by the further motor control device 22B varies with the torque requirement 44 until the motor control devices produce equal torques 22, see time TG. From the TG point on, the additional motor control device 22B produces a torque that corresponds to that of the single motor control device 22A originally used. The further increase in the torque requirement 44 leads to the fact that the power outputs of the motor control devices 22 are adjusted together and in parallel, so that a corresponding increase in the torques generated is caused. Regarding the time TG, a corresponding further torque threshold value, for example a second torque threshold value, can of course be defined with knowledge of the first torque threshold value 48.

As soon as the torque requirement 44 falls sufficiently again, different torques are again caused by the motor control devices 22. After time T2, the torque requirement 44 has fallen below the first torque threshold 48, which is why only a single motor control device 22A is used. If, in relation to the torque curves 40, 42, the process and the steering system 12, the same torques or the same electrical power output of the motor control devices 22, a pairwise difference between corresponding values is permissible, provided that the difference is less than a predetermined difference threshold. The torques caused or the electrical power output do not have to be exactly the same.

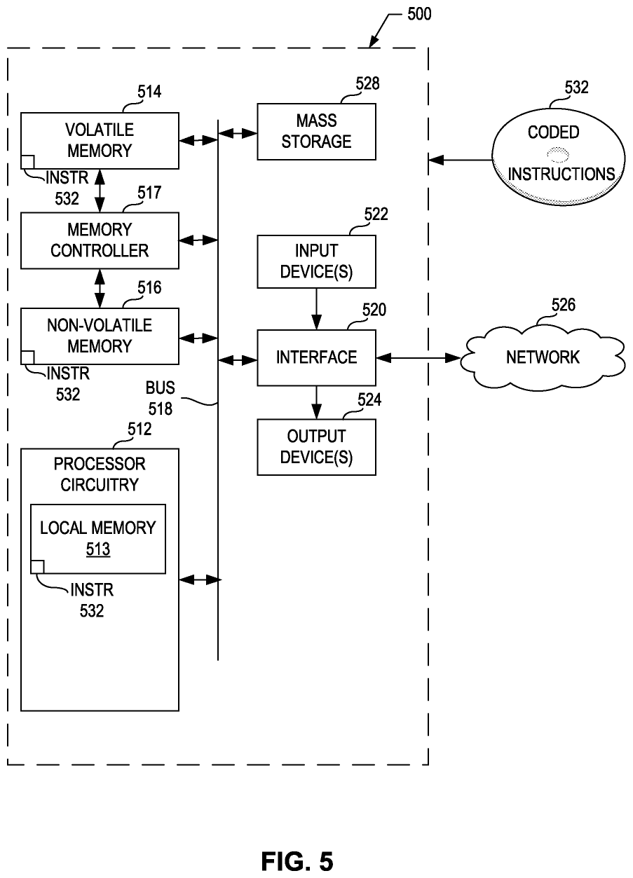

FIG. 5 is a block diagram of an example programmable circuitry platform 500 structured to execute and/or instantiate the example machine-readable instructions and/or the example operations of FIG. [Flowcharts] to implement examples disclosed herein. The programmable circuitry platform 500 can be, for example, a control device, an electronic control unit (ECU), a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 512 may be implemented by one or more semiconductor based (e.g., silicon based) devices.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a button, a touchscreen, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 532, which may be implemented by the machine-readable instructions of FIG. [Flowcharts], may be stored in the mass storage device 528, in the volatile memory 514, in the non-volatile memory 516, and/or on at least one non-transitory computer readable storage medium such as a CD or DVD which may be removable.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent. Further examples and combinations thereof include the following:
Example 1 includes a steer-by-wire (SBW) steering system comprising an electric motor including a first winding set and a second winding set, a first motor control device to apply first phase voltages to the first winding set based on a torque request associated with the electric motor, and a second motor control device coupled to the first motor control device to apply second phase voltages to the second winding set when the torque request is greater than a first threshold.
Example 2 includes the SBW steering system of example 1, wherein when the torque request is greater than the first threshold, a pairwise difference between a first torque associated with the first motor control device and a second torque associated with the second motor control device is less than a predetermined differential threshold.
Example 3 includes the SBW steering system of any one or more of examples 1-2, wherein a first torque associated with the first motor control device is constant and a second torque associated with the second motor control device is variable based on the torque request and the first torque.
Example 4 includes the SBW steering system of example 3, wherein the second torque is varied based on a pairwise difference between the first torque and the second torque.
Example 5 includes the SBW steering system of example 4, wherein the second torque is varied so that the pairwise difference is less than a predetermined differential threshold.
Example 6 includes the SBW steering system of any one or more of examples 1-5, wherein the electric motor implements a road wheel actuator or a hand wheel actuator.
Example 7 includes the SBW steering system of any one or more of examples 1-6, wherein the first threshold is based on a speed of a vehicle associated with the SBW steering system.
Example 8 includes a non-transitory computer readable storage medium comprising instructions to cause at least one programmable circuitry to select a first motor control device or a second motor control device based on a first temperature of the first motor control device and a second temperature of the second motor control device, cause at least one of the first motor control device or the second motor control device to apply first phase voltages to a first winding set of an electric motor based on the selection and a torque request associated with the electric motor, and when the torque request associated with the electric motor is greater than a first threshold, cause at least one of the first motor control device or the second motor control device to apply second phase voltages to a second winding set of the electric motor.
Example 9 includes the non-transitory computer readable storage medium of example 8, wherein the first motor control device or the second motor control device is selected further based on at least one of an ageing state of the first motor control device or the second motor control device, a relative position of the first winding set and the second winding set to a rotor of the electric motor, or position data of a rotor position encoder associated with the first winding set or the second winding set.
Example 10 includes the non-transitory computer readable storage medium of any one or more of examples 8-9, wherein when the torque request is greater than the first threshold, a pairwise difference between a first torque associated with the first motor control device and a second torque associated with the second motor control device is less than a predetermined differential threshold.
Example 11 includes the non-transitory computer readable storage medium of any one or more of examples 8-10, wherein a first torque associated with the first motor control device is constant and a second torque associated with the second motor control device is variable based on the torque request and the first torque.
Example 12 includes the non-transitory computer readable storage medium of example 11, wherein the second torque is varied based on a pairwise difference between the first torque and the second torque.
Example 13 includes the non-transitory computer readable storage medium of example 12, wherein the second torque is varied so that the pairwise difference is less than a predetermined differential threshold.
Example 14 includes the non-transitory computer readable storage medium of any one or more of examples 8-13, wherein the electric motor implements a road wheel actuator or a hand wheel actuator.
Example 15 includes the non-transitory computer readable storage medium of any one or more of examples 8-14, wherein the first threshold is based on a speed of a vehicle associated with the electric motor.
Example 16 includes a method comprising selecting a first motor control device or a second motor control device based on a first temperature of the first motor control device and a second temperature of the second motor control device, causing at least one of the first motor control device or the second motor control device to apply first phase voltages to a first winding set of an electric motor based on the selection and a torque request associated with the electric motor, and when the torque request associated with the electric motor is greater than a first threshold, causing at least one of the first motor control device or the second motor control device to apply second phase voltages to a second winding set of the electric motor.
Example 17 includes the method of example 16, wherein the first motor control device or the second motor control device is selected further based on at least one of an ageing state of the first motor control device or the second motor control device, a relative position of the first winding set and the second winding set to a rotor of the electric motor, or position data of a rotor position encoder associated with the first winding set or the second winding set.
Example 18 includes the method of any one or more of examples 16-17, wherein when the torque request is greater than the first threshold, a pairwise difference between a first torque associated with the first motor control device and a second torque associated with the second motor control device is less than a predetermined differential threshold.
Example 19 includes the method of any one or more of examples 16-18, wherein a first torque associated with the first motor control device is constant and a second torque associated with the second motor control device is variable based on the torque request and the first torque.
Example 20 includes the method of example 19, wherein the second torque is varied based on a pairwise difference between the first torque and the second torque.

What is claimed is:

1. A steer-by-wire (SBW) steering system comprising:
an electric motor including a first winding set and a second winding set;
a first motor control device to apply first phase voltages to the first winding set based on a torque request associated with the electric motor; and
a second motor control device coupled to the first motor control device to apply second phase voltages to the second winding set when the torque request is greater than a first threshold.

2. The SBW steering system of claim 1, wherein when the torque request is greater than the first threshold, a pairwise difference between a first torque associated with the first motor control device and a second torque associated with the second motor control device is less than a predetermined differential threshold.

3. The SBW steering system of claim 1, wherein a first torque associated with the first motor control device is constant and a second torque associated with the second motor control device is variable based on the torque request and the first torque.

4. The SBW steering system of claim 3, wherein the second torque is varied based on a pairwise difference between the first torque and the second torque.

5. The SBW steering system of claim 4, wherein the second torque is varied so that the pairwise difference is less than a predetermined differential threshold.

6. The SBW steering system of claim 1, wherein the electric motor implements a road wheel actuator or a hand wheel actuator.

7. The SBW steering system of claim 1, wherein the first threshold is based on a speed of a vehicle associated with the SBW steering system.

8. A non-transitory computer readable storage medium comprising instructions to cause at least one programmable circuitry to:
select a first motor control device or a second motor control device based on a first temperature of the first motor control device and a second temperature of the second motor control device;
cause at least one of the first motor control device or the second motor control device to apply first phase voltages to a first winding set of an electric motor based on the selection and a torque request associated with the electric motor; and
when the torque request associated with the electric motor is greater than a first threshold, cause at least one of the first motor control device or the second motor control device to apply second phase voltages to a second winding set of the electric motor.

9. The non-transitory computer readable storage medium of claim 8, wherein the first motor control device or the second motor control device is selected further based on at least one of:
an ageing state of the first motor control device or the second motor control device;
a relative position of the first winding set and the second winding set to a rotor of the electric motor; or motor control device;
position data of a rotor position encoder associated with the first winding set or the second winding set.

10. The non-transitory computer readable storage medium of claim 8, wherein when the torque request is greater than the first threshold, a pairwise difference between a first torque associated with the first motor control device and a second torque associated with the second motor control device is less than a predetermined differential threshold.

11. The non-transitory computer readable storage medium of claim 8, wherein a first torque associated with the first motor control device is constant and a second torque associated with the second motor control device is variable based on the torque request and the first torque.

12. The non-transitory computer readable storage medium of claim 11, wherein the second torque is varied based on a pairwise difference between the first torque and the second torque.

13. The non-transitory computer readable storage medium of claim 12, wherein the second torque is varied so that the pairwise difference is less than a predetermined differential threshold.

14. The non-transitory computer readable storage medium of claim 8, wherein the electric motor implements a road wheel actuator or a hand wheel actuator.

15. The non-transitory computer readable storage medium of claim 8, wherein the first threshold is based on a speed of a vehicle associated with the electric motor.

16. A method comprising:
selecting a first motor control device or a second motor control device based on a first temperature of the first motor control device and a second temperature of the second motor control device;
causing at least one of the first motor control device or the second motor control device to apply first phase voltages to a first winding set of an electric motor based on the selection and a torque request associated with the electric motor; and
when the torque request associated with the electric motor is greater than a first threshold, causing at least one of the first motor control device or the second motor control device to apply second phase voltages to a second winding set of the electric motor.

17. The method of claim 16, wherein the first motor control device or the second motor control device is selected further based on at least one of:
an ageing state of the first motor control device or the second motor control device;
a relative position of the first winding set and the second winding set to a rotor of the electric motor; or motor control device;
position data of a rotor position encoder associated with the first winding set or the second winding set.

18. The method of claim 16, wherein when the torque request is greater than the first threshold, a pairwise difference between a first torque associated with the first motor control device and a second torque associated with the second motor control device is less than a predetermined differential threshold.

19. The method of claim 16, wherein a first torque associated with the first motor control device is constant and a second torque associated with the second motor control device is variable based on the torque request and the first torque.

20. The method of claim 19, wherein the second torque is varied based on a pairwise difference between the first torque and the second torque.
